(19) United States
(12) Patent Application Publication
(10) Pub. No.: US 2016/0109146 A1
(43) Pub. Date: Apr. 21, 2016

(54) METHOD AND DEVICE FOR CONTROLLING AIR CONDITIONING SYSTEM

(71) Applicants: Guanglei ZHANG, Beijing (CN); Jichuan ZHENG, Beijing (CN)

(72) Inventors: Guanglei ZHANG, Beijing (CN); Jichuan ZHENG, Beijing (CN)

(21) Appl. No.: 14/878,165

(22) Filed: Oct. 8, 2015

(30) Foreign Application Priority Data
Oct. 20, 2014 (CN) 201410558426.9

(51) Int. Cl. F24F 11/00; G05B 15/02; F24F 11/02

(52) U.S. Cl. CPC F24F 11/006; F24F 11/001; F24F 11/02; G05B 15/02; F24F 2011/0046; F24F 2011/0047; F24F 2011/0061; F24F 2011/0064; F24F 2011/0067; F24F 2011/0068; F24F 2011/0075

(57) ABSTRACT

Disclosed is a control method of controlling an air conditioning system. The control method comprises steps of obtaining plural adjustment parameter groups of each of plural air conditioners contained in the air conditioning system; acquiring at least one desired environmental parameter of each of one or more control targets; selecting, based on the desired environmental parameters, one from the plural adjustment parameter groups of each of the plural air conditioners to serve as a target adjustment parameter group of the corresponding air conditioner; and respectively transmitting the plural target adjustment parameter groups to the plural air conditioners, so that the plural air conditioners respectively set their adjustment functions according to the plural target adjustment parameter groups.

### BACKGROUND OF THE INVENTION

1. Field of the Invention

The present invention relates to a method and device for controlling an air conditioning system, and particularly relates to a method and device for controlling an air conditioning system containing plural air conditioners.

2. Description of the Related Art

Up to now, air conditioning systems containing air conditioners have been widely provided in buildings, etc., so as to improve the living environments of people. In the conventional method of controlling an air conditioning system, the switching control thereof is usually on the basis of a predetermined temperature. For example, if the environmental temperature is less than the predetermined temperature, then the air conditioning system operates according to a predetermined wind velocity and/or wind direction, and if the environmental temperature is greater than or equal to the predetermined temperature, then the air conditioning system stops the operation. However, this kind of switching control may result in a large amount of electric power consumption, thereby bringing economic crises, greenhouse effect, climate change, etc. In order to improve this kind of switching control, an inverter air conditioning system has been proposed in which by changing the working frequency of a compressor thereof, it is possible to slowly change the environmental temperature, and to reduce the number of starts and stops of the compressor.

Actually, in a space where an air conditioning system containing plural air conditioners is provided, there may exist one or more control targets (also called “target positions”) whose surrounding air environments (also called “environments”) need to be adjusted by the air conditioning system, and each of the one or more control targets may receive the joint influence of at least a part of the plural air conditioners in the air conditioning system. However, in this kind of conventional air conditioning system, when automatic air adjustment is being conducted, it is difficult to take account of the joint influence of all the possible air conditioners thereof and/or the demand of each of the one or more control targets.

### SUMMARY OF THE INVENTION

The objective of the embodiments of the present invention is to provide a method and device for controlling an air conditioning system so as to solve the above-described problem.

According to a first aspect of the present invention, a method of controlling an air conditioning system containing plural air conditioners is provided. Each of the plural air conditioners has at least one adjustment function able to conduct adjustment with respect to air. The method comprises:

an obtainment step of obtaining plural adjustment parameter groups of each of the plural air conditioners, wherein, each of the plural adjustment parameter groups of the corresponding air conditioner includes at least one adjustment parameter corresponding to the at least one adjustment function of the corresponding air conditioner, and a value of the at least one adjustment parameter indicates an operating state of the corresponding at least one adjustment function;

an acquirement step of acquiring at least one desired environmental parameter of each of one or more control targets;

a selection step of selecting, based on the desired environmental parameters, one from the plural adjustment parameter groups of each of the plural air conditioners to serve as a target adjustment parameter group of the corresponding air conditioner, wherein, at least one actual environmental parameter of each of the one or more control targets, which is obtained by conducting joint adjustment with respect to the corresponding control target by the plural air conditioners according to their target adjustment parameter groups, is closer to the corresponding at least one desired environmental parameter than that obtained by conducting adjustment with respect to the corresponding control target by the plural air conditioners according to their remaining adjustment parameter groups; and

a transmission step of respectively transmitting the plural target adjustment parameter groups to the plural air conditioners, so that the plural air conditioners respectively set their adjustment functions according to the plural target adjustment parameter groups.

According to a second aspect of the present invention, a device for controlling an air conditioning system containing plural air conditioners is provided. Each of the plural air conditioners has at least one adjustment function able to conduct adjustment with respect to air. The device comprises:

an obtainment part configured to obtain plural adjustment parameter groups of each of the plural air conditioners, wherein, each of the plural adjustment parameter groups of the corresponding air conditioner includes at least one adjustment parameter corresponding to the at least one adjustment function of the corresponding air conditioner, and a value of the at least one adjustment parameter indicates an operating state of the corresponding at least one adjustment function;

an acquirement part configured to acquire at least one desired environmental parameter of each of one or more control targets;

a selection part configured to select, based on the desired environmental parameters, one from the plural adjustment parameter groups of each of the plural air conditioners to serve as a target adjustment parameter group of the corresponding air conditioner, wherein, at least one actual environmental parameter of each of the one or more control targets, which is obtained by conducting joint adjustment with respect to the corresponding control target by the plural air conditioners according to their target adjustment parameter groups, is closer to the corresponding at least one desired environmental parameter than that obtained by conducting adjustment with respect to the corresponding control target by the plural air conditioners according to their remaining adjustment parameter groups; and

a transmission part configured to respectively transmit the plural target adjustment parameter groups to the plural air conditioners, so that the plural air conditioners respectively set their adjustment functions according to the plural target adjustment parameter groups.

As a result, in the method and device for controlling the air conditioning system according to the embodiments of the present invention, it is possible to conduct automatic control with respect to each of the plural air conditioners in the air conditioning system on the basis of the joint influence of all the possible air conditioners on one control target, and in a case in which there exist plural control targets having different desired environments in a space where the air conditioning system is provided, it is also possible to take account of the demand of each of the plural control targets so as to conduct the automatic control.

### BRIEF DESCRIPTION OF THE DRAWINGS

FIG. 1 illustrates a first exemplary scenario in which the present invention may be applied;

FIG. 2 illustrates a second exemplary scenario in which the present invention may be applied;

FIG. 3 is a flowchart of a method of controlling an air conditioning system, according to an embodiment of the present invention;

FIG. 4 is a block diagram of a device for controlling an air conditioning system, according to an embodiment of the present invention; and

FIG. 5 is a block diagram of a system for controlling an air conditioning system, according to an embodiment of the present invention.

### DETAILED DESCRIPTION OF THE PREFERRED EMBODIMENTS

In order to let those people skilled in the art better understand the present invention, hereinafter the present invention will be concretely described on the basis of the drawings and various embodiments.

In the embodiments of the present invention, an air conditioning system contains plural air conditioners. Particularly, the plural air conditioners in the air conditioning system may be provided in a same space. Each of the plural air conditioners may have at least one adjustment function able to conduct adjustment with respect to air. For example, each of the plural air conditioners may have at least one adjustment function such as a wind volume adjustment function, a wind direction adjustment function, and/or an air humidity adjustment function. Each of the plural air conditioners may include but is not limited to a fan, a cooler, a heater, an integrated or split air conditioning unit, etc.

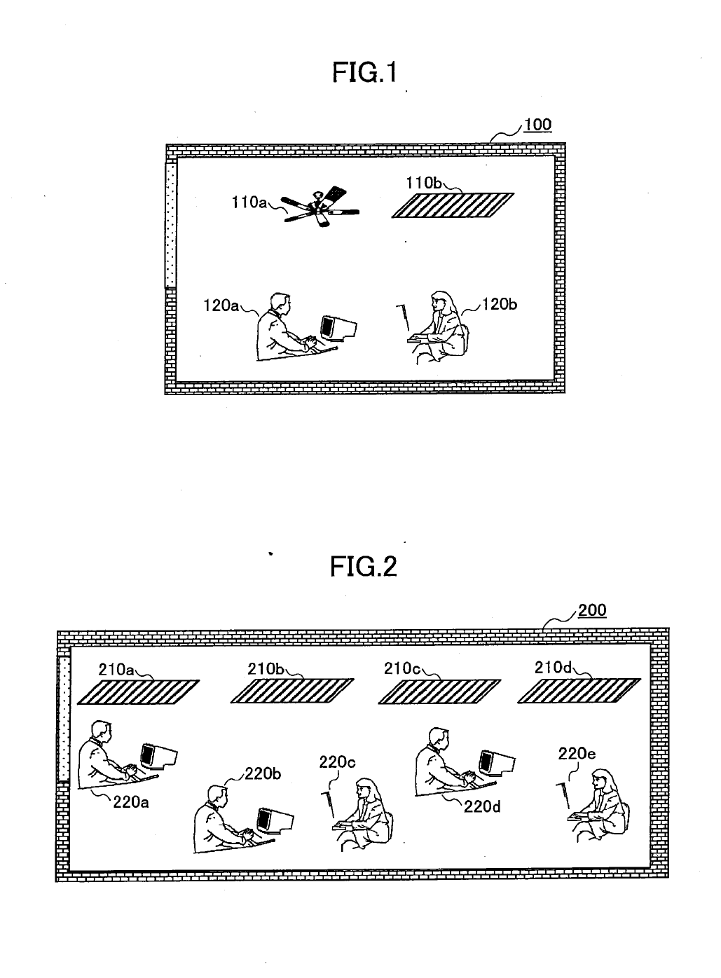

FIG. 1 illustrates a first exemplary scenario in which the present invention may be applied.

As shown in FIG. 1, in a space 100, an air conditioning system is provided which includes an electric fan 110a and a ceiling mounted air conditioner 110b. The electric fan 110a has a wind velocity adjustment function. For example, the electric fan 110a may adjust the rotation velocity of its flabella by setting its output to a strong, medium, or weak level. The ceiling mounted air conditioner 110b has a wind velocity adjustment function and a wind direction adjustment function. In the space 100, there exist control targets 120a and 120b having different desired environments, and each of the control targets 120a and 120b may receive the joint influence of the electric fan 110a and the ceiling mounted air conditioner 110b.

FIG. 2 illustrates a second exemplary scenario in which the present invention may be applied.

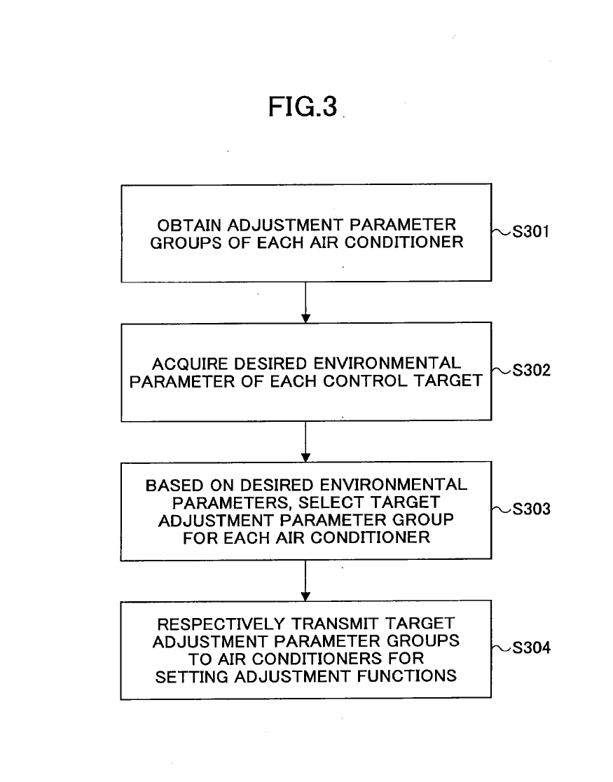

As shown in FIG. 2, in a space 200, an air conditioning system is provided which contains ceiling mounted conditioners 210a to 210d. Each of the ceiling mounted conditioners 210a to 210d has two adjustment functions, i.e., a wind direction adjustment function and a wind velocity adjustment function. Particularly, each of the ceiling mounted air conditioners 210a to 210d has five types of wind directions (i.e., Types 1 to 5) and two levels of wind velocities (i.e., Strong and Weak levels) which may be selected. In the space 200, there exist control targets 220a to 220e having different desired environments, and each of the control targets 220a to 220e may receive the joint influence of the ceiling mounted air conditioners 210a to 210d. FIG. 3 is a flowchart of a method of controlling an air conditioning system, according to an embodiment of the present invention.

In what follows, the method (also called a “control method”) of controlling the air conditioning system will be illustrated by referring to FIGS. 2 and 3.

As shown in FIG. 3, the control method includes STEPS S301 to S304. In STEP S301, plural adjustment parameter groups of each of plural air conditioners in the air conditioning system are obtained. Each of the plural adjustment parameter groups of each of the plural air conditioners includes at least one adjustment parameter corresponding to at least one adjustment function of the corresponding air conditioner, and a value of the at least one adjustment parameter represents an operating state of the corresponding at least one adjustment function.

In an example, it is possible to, regarding each of the plural air conditioners in the air conditioning system, conduct a general search with respect to all the possible operating states of the at least one adjustment function of the corresponding air conditioner, so as to generate the adjustment parameters corresponding to all the possible operating states of the corresponding adjust function of the corresponding air conditioner, and then to generate plural adjustment parameter groups for the corresponding air conditioner on the basis of the generated adjustment parameters. Here it should be noted there exists at least one adjustment parameter whose values in any two adjustment parameter groups of each of the plural air conditioners are different.

For instance, in the second exemplary scenario shown in FIG. 2, as described above, each of the ceiling mounted air conditioners 210a to 210d has five types of wind directions and two levels of wind velocities. As such, the plural adjustment parameter groups of each of the ceiling mounted air conditioners 210a to 210d may contain a wind direction parameter and a wind velocity parameter. The value of the wind direction parameter may be one of 1 to 5 respectively indicating the five types of wind directions, and the value of the wind velocity parameter may be one of Strong and Weak respectively indicating the two levels of wind velocities. Regarding each of the ceiling mounted air conditioners 210a to 210d, by combining the five wind direction parameter values and the two wind velocity parameter values, it is possible to obtain the following Table 1 in which there are ten (i.e., 5*2=10) adjustment parameter groups for the corresponding ceiling mounted air conditioner. Here it should be noted that for the sake of convenience, the wind velocity parameter value is only represented by Strong or Weak without taking account of the relevant directions. If taking account of the relevant directions, then it is possible to express the wind velocity parameter value as a vector (X,Y,Z) in which the components X and Y are along the horizontal direction, and the component Z is along the vertical direction.

TABLE 1

| Air Conditioner | Wind Direction | Wind Velocity |
|---|---|---|
| 210a | 1 | Strong |
| | | Weak |
| | 2 | Strong |
| | | Weak |
| | 3 | Strong |
| | | Weak |
| | 4 | Strong |
| | | Weak |
| | 5 | Strong |
| | | Weak |
| 210b | 1 | Strong |
| | | Weak |
| | 2 | Strong |
| | | Weak |
| | 3 | Strong |
| | | Weak |
| | 4 | Strong |
| | | Weak |
| | 5 | Strong |
| | | Weak |
| 210c | 1 | Strong |
| | | Weak |
| | 2 | Strong |
| | | Weak |
| | 3 | Strong |
| | | Weak |
| | 4 | Strong |
| | | Weak |
| | 5 | Strong |
| | | Weak |
| 210d | 1 | Strong |
| | | Weak |
| | 2 | Strong |
| | | Weak |
| | 3 | Strong |
| | | Weak |
| | 4 | Strong |
| | | Weak |
| | 5 | Strong |
| | | Weak |

In STEP S302 of FIG. 3, at least one desired environmental parameter of each of one or more control targets is obtained. Particularly, in STEP S302, at least one desired environmental parameter of each of one or more control targets in a space, where the air conditioning system containing the plural air conditioners is provided, is obtained.

In an example, there may exist one control target in the space. In this case, in STEP S302, at least one desired environmental parameter of the one control target is obtained. Alternatively, there may exist plural control targets in the space. In this case, in STEP S302, at least one desired environmental parameter of each of the plural control targets in the space are obtained.

Additionally, in an example, it is possible to predetermine at least one desired environmental parameter of each of the one or more control targets, or to determine them on the basis of real-time feedback. For instance, in the second exemplary scenario shown in FIG. 2, it is possible to predetermine, by a user sitting at each of the target positions 220a to 220e, at least one desired environment for the corresponding target position, and then to generate at least one desired environmental parameter for the corresponding target position. Also the user sitting at each of the target positions 220a to 220e may determine or adjust the at least one desired environmental parameter of the corresponding target position on the basis of his/her feeling regarding the current environment, i.e., on the basis of real-time feedback.

For instance, the user may input, in real time, information about at least one of “too wet”, “too cold”, “too hot”, and so on. As such, in STEP S302 of FIG. 3, it is also possible to convert this kind of information into the at least one desired environmental parameter or its adjustment value. In general, the feeling of a user with respect to a thermal environment may receive the joint influence of environmental factors such as temperature, air humidity, and air flow. As such, it is possible to convert the feeling of the user about the thermal environmental into at least one desired environmental parameter or its adjustment value according to various standardized thermal comfort indices such as SET (Standard Effective Temperature), PMV (Predicted Mean Vote), and the like.

Here it should be noted that in FIG. 3, although STEP S301 is conducted before STEP S302, the present invention is not limited to this. For example, STEP S301 may be conducted after STEP S302, or STEPS S301 and S302 may be conducted at the same time, i.e., in parallel.

After that, in STEP S303 of FIG. 3, it is possible to select, on the basis of the desired environmental parameters, an adjustment parameter group from the plural adjustment parameter groups of each of the plural air conditioners to serve as a target adjustment parameter group of the corresponding air conditioner. Here at least one actual environmental parameter of each of the one or more control targets, which is obtained by conducting joint adjustment with respect to the corresponding control target on the basis of the plural target adjustment parameter groups of the plural air conditioners, is closer to the at least one desired environmental parameter of the corresponding control target than that of the corresponding control target which is obtained by conducting adjustment with respect to the corresponding control target on the basis of the remaining adjustment parameter groups different from the selected adjustment parameter groups of the plural air conditioners. The at least one actual environmental parameter and its corresponding desired environmental parameter may include a parameter related to at least one same environmental factor, for example, wind power, a wind direction, temperature, or air humidity.

In addition, as described above, each of the one or more control targets may receive the joint influence of the plural air conditioners in the air conditioning system. As such, when the plural air conditioners conduct joint adjustment with respect to each of the one or more control targets by utilizing the plural target adjustment parameter groups, the at least one actual environmental parameter of the corresponding control target is based on the superposition of adjustment effects at the corresponding control target, generated by the plural air conditioners. Here it should be noted that it is possible to predetermine an approach of conducting the superposition of the adjustment effects generated by the plural air conditioners, for example, a linear superposition approach. Alternatively, it is possible to give a weight to each of the plural air conditioners in advance, and then to carry out the superposition of the adjustment effects generated by the plural air conditioners on the basis of their weights.

In an example, the control method shown in FIG. 3 may further include a taking step of taking (obtaining), in advance, the adjustment effect generated by each of the plural air conditioners when the corresponding air conditioner conducts adjustment with respect to each of the one or more control targets by using each of the plural adjustment parameter groups of the corresponding air conditioner. It is possible to detect, in advance, the adjustment effect generated by each of the plural air conditioners when the corresponding air conditioner conducts adjustment with respect to each of the one or more control targets by utilizing each of the plural adjustment parameter groups of the corresponding air conditioner.

For instance, in the second exemplary scenario shown in FIG. 2, as described above, each of the ceiling mounted air conditioners 210a to 210d has ten adjustment parameter groups. In this case, it is possible to let, in advance, the ceiling mounted air conditioners 210a to 210d independently operate one by one when there is nobody in the space (e.g., at the night). Here, in the independent operating period of each of the ceiling mounted air conditioners 210a to 210d, the corresponding ceiling mounted air conditioner may sequentially operate by using each of its ten adjustment parameter groups. Meanwhile it is possible to detect and record the adjustment effect at each of the control targets 220a to 220e, generated by each of the ceiling mounted air conditioners 210a to 210d when the corresponding ceiling mounted air conditioner conducts adjustment with respect to the corresponding control target by utilizing each of the ten adjustment parameter groups of the corresponding air conditioner. Here it should be noted that aside from actually detecting the adjustment effects generated by the ceiling mounted air conditioners 210a to 210d, it is also possible to carry out simulation, prediction, and the like on the basis of the relevant physical rules, so as to predetermine the adjustment effects generated by the ceiling mounted conditioners 210a to 210d when they conduct adjustment with respect to the control targets 220a to 220e by using their adjustment parameter groups.

Moreover the control method shown in FIG. 3 may further include a generation step of generating environment adjustment parameters corresponding to the adjustment effects generated by the plural air conditioners. Optionally it is possible to generate, by conducting offline training, the environment adjustment parameters corresponding to the adjustment effects generated by the plural air conditioners. Here it should be noted that an environment adjustment parameter may indicate the change of the corresponding adjustment effect with respect to the corresponding actual environmental parameter. As such, by generating these kinds environment adjustment parameters, it is possible to obtain the mapping relationship between the at least one adjustment parameter of each of the plural air conditioners and the corresponding at least one actual environmental parameter.

For instance, an environment adjustment parameter may be an actual wind velocity parameter, an actual wind power parameter, a temperature change parameter, or an air humidity change parameter which may be determined on the basis of an obtained adjustment effect. Particularly, in the second exemplary scenario shown in FIG. 2, if it is assumed that an environment adjustment parameter is an actual wind velocity parameter (unit: m/s), then after conducting the above-described taking step, it is possible to generate the environment adjustment parameter (i.e., the actual wind velocity parameter) for each of the control targets 220a to 220e, as shown in the following Table 2.

Additionally, aside from determining, on the basis of the desired environmental parameters, the target adjustment parameter groups of the plural air conditioners, the control method shown in FIG. 3 may further include a determination step of determining, on the basis of at least one environment adjustment parameter, the target adjustment parameter group of each of the air conditioners. That is, it is possible to determine, on the basis of the at least one desired environmental parameter and its corresponding environment adjustment parameter, the target adjustment parameter group of each of the plural air conditioners.

TABLE 2

| | | | Wind | Wind | Wind | Wind | Wind |
|---|---|---|---|---|---|---|---|
| Air | Wind | Wind | Velocity | Velocity | Velocity | Velocity | Velocity |
| Conditioner | Direction | Velocity | of 220a | of 220b | of 220c | of 220d | of 220e |
| 210a | 1 | Strong | 0.000 | 0.000 | 0.000 | 0.000 | 0.000 |
| | | Weak | 0.000 | 0.000 | 0.000 | 0.000 | 0.000 |
| | 2 | Strong | 0.001 | 0.000 | 0.000 | 0.000 | 0.045 |
| | | Weak | 0.000 | 0.000 | 0.000 | 0.000 | 0.004 |
| | 3 | Strong | 0.001 | 0.000 | 0.000 | 0.000 | 0.038 |
| | | Weak | 0.000 | 0.000 | 0.000 | 0.000 | 0.000 |
| | 4 | Strong | 0.000 | 0.000 | 0.000 | 0.000 | 0.006 |
| | | Weak | 0.000 | 0.000 | 0.000 | 0.000 | 0.000 |
| | 5 | Strong | 0.000 | 0.000 | 0.000 | 0.000 | 0.000 |
| | | Weak | 0.000 | 0.000 | 0.000 | 0.000 | 0.000 |
| 210b | 1 | Strong | 0.004 | 0.073 | 0.000 | 0.000 | 0.000 |
| | | Weak | 0.000 | 0.001 | 0.000 | 0.000 | 0.000 |
| | 2 | Strong | 0.045 | 0.143 | 0.000 | 0.000 | 0.000 |
| | | Weak | 0.004 | 0.000 | 0.000 | 0.000 | 0.000 |
| | 3 | Strong | 0.084 | 0.000 | 0.001 | 0.000 | 0.000 |
| | | Weak | 0.023 | 0.000 | 0.000 | 0.000 | 0.000 |
| | 4 | Strong | 0.031 | 0.000 | 0.024 | 0.000 | 0.000 |
| | | Weak | 0.000 | 0.000 | 0.004 | 0.000 | 0.000 |
| | 5 | Strong | 0.002 | 0.000 | 0.121 | 0.000 | 0.000 |
| | | Weak | 0.000 | 0.000 | 0.047 | 0.000 | 0.000 |
| 210c | 1 | Strong | 0.000 | 0.000 | 0.000 | 0.073 | 0.000 |
| | | Weak | 0.000 | 0.000 | 0.000 | 0.001 | 0.000 |
| | 2 | Strong | 0.000 | 0.000 | 0.000 | 0.143 | 0.000 |
| | | Weak | 0.000 | 0.000 | 0.000 | 0.000 | 0.000 |
| | 3 | Strong | 0.000 | 0.000 | 0.001 | 0.000 | 0.000 |
| | | Weak | 0.000 | 0.000 | 0.000 | 0.000 | 0.000 |
| | 4 | Strong | 0.000 | 0.000 | 0.024 | 0.000 | 0.000 |
| | | Weak | 0.000 | 0.000 | 0.004 | 0.000 | 0.000 |
| | 5 | Strong | 0.000 | 0.000 | 0.121 | 0.000 | 0.000 |
| | | Weak | 0.000 | 0.000 | 0.047 | 0.000 | 0.000 |
| 210d | 1 | Strong | 0.000 | 0.000 | 0.000 | 0.000 | 0.000 |
| | | Weak | 0.000 | 0.000 | 0.000 | 0.000 | 0.000 |
| | 2 | Strong | 0.000 | 0.000 | 0.000 | 0.000 | 0.000 |
| | | Weak | 0.000 | 0.000 | 0.000 | 0.000 | 0.000 |
| | 3 | Strong | 0.000 | 0.000 | 0.000 | 0.000 | 0.000 |
| | | Weak | 0.000 | 0.000 | 0.000 | 0.000 | 0.000 |
| | 4 | Strong | 0.000 | 0.000 | 0.000 | 0.000 | 0.000 |
| | | Weak | 0.000 | 0.000 | 0.000 | 0.000 | 0.000 |
| | 5 | Strong | 0.000 | 0.000 | 0.000 | 0.000 | 0.000 |
| | | Weak | 0.000 | 0.000 | 0.000 | 0.000 | 0.000 |

Furthermore, in an example, the control method shown in FIG. 3 may further include a setting step of setting a predetermined condition for the at least one actual environmental parameter and its corresponding desired environmental parameter of each of the one or more control targets. In this case, if it is said that the at least one actual environmental parameter is closer to its corresponding desired environmental parameter, then that means the relationship between the two satisfy the predetermined condition. Since the at least one actual environmental parameter and its desired environmental parameter of each of the one or more control targets are taken into account when setting the corresponding predetermined condition, it is possible to better consider, when conducting joint adjustment with respect to the one or more control targets on the basis of the target adjustment parameter groups of the plural conditioners (i.e., when satisfying the one or more predetermined conditions), the desired environmental parameters of the one or more control targets, so that the at least one actual environmental parameter of each of the one or more control targets may be as close as possible to the corresponding desired environmental parameter.

As described above, an actual environmental parameter and its corresponding desired environmental parameter may be one related to a same environmental factor (e.g., a wind velocity parameter). In this case, the predetermined condition may be one related to the value difference between the actual and its corresponding environmental parameters. For instance, the predetermined condition may be that the sum of the value differences between the actual environmental parameters and their corresponding desired environmental parameters of the one or more control targets is minimum. Here it should be noted that if there exists only one control target, then the sum of the value differences may be the value difference between the at least one actual environmental parameter and its corresponding desired environmental parameter of the one control target. Again, for instance, the predetermined condition may be that the sum of squares of the value differences between the actual environmental parameters and their corresponding desired environmental parameters of the one or more control targets is minimum. Here it should be noted that if there exist only one control target, then the sum of squares of the value differences may be the square of the value difference between the at least one actual environmental parameter and its corresponding desired environmental parameter of the one control target.

In an example, if the predetermined condition is that the sum of squares of the value differences between the actual environmental parameters and their corresponding desired environmental parameters of the one or more control targets is minimum, then it is possible to select, from the plural adjustment parameter groups of each of the plural air conditioners, the target adjustment parameter group for the corresponding air conditioner on the basis of the at least one desired environmental parameter and its corresponding environment adjustment parameter of each of the one or more control targets by using a least squares fitting approach. In this case, the sum of squares of the value differences between the actual environmental parameters and their corresponding desired environmental parameters of the one or more control targets, which is acquired by conducting joint adjustment with respect to the one or more control targets on the basis of the plural target adjustment parameter groups of the plural air conditioners, is more minimum than that acquired by conducting adjustment with respect to the one or more control targets on the basis of the remaining (non-selected) adjustment parameter groups of the plural air conditioners.

In what follows, an example of how to determine the target adjustment parameter group of each of the plural air conditioners by utilizing least squares fitting will be given on the basis of FIG. 2.

Here it is assumed that in the second exemplary scenario shown in FIG. 2, at least one actual environmental parameter and its corresponding desired environmental parameter of each of the one or more control targets 220a to 220e refer to a wind velocity. As described above, in the second exemplary scenario shown in FIG. 3, each of the ceiling mounted air conditioners 210a to 210d has ten adjustment parameter groups, so the ceiling mounted air conditioners 210a to 210d have forty adjustment parameter groups in total. Additionally it is assumed that in the second exemplary scenario shown in FIG. 2, the adjustment effect at each of the control targets 220a to 220e is the linear superposition of the adjustment effects at the corresponding control target, generated by the ceiling mounted air conditioners 210a to 210d. As such, in this example, in order to let the sum of squares of the value differences between the actual wind velocities and their corresponding desired wind velocities of the control targets 220a to 220e be minimum so as to cause the wind velocity of each of the control targets 220a to 220e to be as close as possible to its corresponding desired wind velocity, it is possible to solve a binary least squares problem shown by the following equation (1).

$${min}_{x ∈ \{ 0 , 1 \}} {‖ Ax - b ‖}^{2} \qquad ( 1 )$$

Here, A refers to the transpose of a matrix related to the wind velocity data shown in Tables 1 and 2; x refers to a linear combination of coefficients corresponding to the forty adjustment parameter groups, whose value range is {0,1} in which 0 stands for Not Selected, and 1 stands for Selected; b refers to the desired wind velocity values (unit: m/s) of the control targets 220a to 220e; and ∥*∥ refers to the Euclidean norm of * (i.e., the L-2 norm).

It may be understood that the ceiling mounted air conditioners 210a to 210d cannot simultaneously operate by using the forty adjustment parameter groups. Actually there exist only four ceiling mounted air conditioners, and each of them has ten adjustment parameter groups, as described above. That is, among the linear combination of coefficients corresponding to the ten adjustment parameter groups of each of the four ceiling mounted air conditioners, only one coefficient can be selected, i.e., its value is 1, and the values of the remaining (non-selected) coefficients are 0. As such, it is necessary to add a constraint condition with respect to the variable x into the above-described binary least squares problem. In other words, among the linear combination of coefficients corresponding to the ten adjustment parameter groups of each of the four ceiling mounted air conditioners, there exists only one coefficient whose value is 1. Here if it is supposed that the linear combination of coefficients corresponding to the ten adjustment parameter groups of each of the four ceiling mounted air conditioners includes x1, x2, . . . , x10, then the equivalent mathematical form of the constraint condition may be expressed by the following equation (2).

$${\sum }_{i = 0}^{10} {x}_{i} = 1 and {x}_{i} {x}_{j} = 0 , i \neq j \qquad ( 2 )$$

Here, xᵢ is a real number, but is not a binary number; and x₀ indicates that a ceiling mounted air conditioner is in its shutdown state.

As a result, it is possible to determine, by solving a least squares problem with the constraint condition shown by the following equation (3), the adjustment parameter group of each of the four ceiling mounted air conditioners, so as to cause the actual wind velocity value of each of the control targets 220a to 220e to be as close as possible to its corresponding desired wind velocity value.

$${min}_{x} {‖ Ax - b ‖}^{2} \\ s . t . {\sum }_{i = 0}^{10} {x}_{i}^{( k )} = 1 and {x}_{i}^{( k )} {x}_{j}^{( k )} = 0 , i \neq j \\ {x}^{( k )} = {[ {x}_{1}^{( k )} {x}_{2}^{( k )} … {x}_{10}^{( k )} ]}^{T} \qquad ( 3 )$$

Here, k stands for the number of the plural air conditioners in the air conditioning system; in this example, k=1, 2, 3, 4. Accordingly it is possible to express x as x=[(x⁽¹⁾)^{T} (x⁽²⁾)^{T} (x⁽³⁾)^{T} (x⁽⁴⁾)^{T}]^{T}.

That is, by utilizing the equation (3), it is possible to transform the binary least squares problem into a continuous least squares problem so as to easily solve the problem. Here it should be noted that it is possible to adopt any proper conventional algorithm to solve the problem shown by the equation (3), for example, the Karush-Kuhn-Tucker (KKT) condition based algorithm or the Lagrangian operator based algorithm. In a case where the Lagrangian operator based algorithm is utilized, the equation (3) may be transformed into the following equation (4) which refers to a least squares problem without constraint.

$${min}_{x} {‖ Ax - b ‖}^{2} + {\sum }_{k = 1}^{4} {λ}_{k} ( 1 - {\sum }_{i = 0}^{10} {x}_{i}^{( k )} ) + {\sum }_{k = 1}^{4} {\sum }_{i \neq j} {τ}_{ij}^{( k )} {x}_{i}^{( k )} {x}_{j}^{( k )} \qquad ( 4 )$$

Here, λₖ and τᵢⱼ^{(k)} stand for two Lagrangian operators corresponding to the two expressions of the constraint condition in the equation (3), and by solving them, it is possible to acquire the following equation (5).

$${\sum }_{i = 0}^{10} {\hat{x}}_{i}^{( k )} = 1 \\ {\hat{x}}_{x}^{( k )} {\hat{x}}_{j}^{( k )} = 0 , i \neq j \qquad ( 5 )$$

Here, \hat{x} denotes the optimal solution of the equation (4), and is a function of the Lagrangian operators λₖ and τᵢⱼ^{(k)}.

Here it should be noted that there are many algorithms able to solve the equation (5) in the conventional techniques, for example, the Trust-Region-Reflective based algorithm and the Levenberg-Marquardt based algorithm.

As a result, in this example, by conducting least squares fitting so as to select, on the basis of the desired environmental parameters and their corresponding environment adjustment parameters, from the plural adjustment parameter groups of each of the plural air conditioners, the target adjustment parameter group of the corresponding air conditioner, it is not necessary to create the internal topological structure related information in a modelling process, and it is easy to expand this to any air conditioning system containing a limited number of air conditioners.

Additionally, considering that the amount of energy consumption should be reduced as much as possible, in an example, the control method may further includes a giving step of giving a weight coefficient to each of the plural adjustment parameter groups of each of the plural air conditioners, so that an adjustment parameter group, by which the amount of energy consumption is relatively small, may be easily selected. For instance, in the second exemplary scenario shown in FIG. 2, in order to cause, while meeting the demands of the control targets 220a to 220e, each of the ceiling mounted air conditioners 210a to 210d to be able to choose a relatively small wind velocity to operate so as to achieve energy saving, it is possible to let, by respectively giving weight coefficients to different wind velocities, a relatively small wind velocity be easily chosen. In particular, it is possible to add a normal item into the equation (4) so as to obtain the following equation (6).

$${min}_{x} {‖ Ax - b ‖}^{2} + {\sum }_{k = 1}^{4} {λ}_{k} ( 1 - {\sum }_{i = 0}^{10} {x}_{i}^{( k )} ) + {\sum }_{k = 1}^{4} {\sum }_{i \neq j} {τ}_{ij}^{( k )} {x}_{i}^{( k )} {x}_{j}^{( k )} + {w}_{ec} {\sum }_{i} {p}_{i} {x}_{i}^{2} \qquad ( 6 )$$

Here, pᵢ refers to the power corresponding to a wind velocity;

$${\sum }_{i} {p}_{i} {x}_{i}^{2}$$

refers to the total power corresponding to a current state x; and w_{ec} refers to the weight coefficient of the total energy consumption with respect to a wind velocity error.

Moreover, in order to further reduce the amount of energy consumption, in an example, the control method shown in FIG. 3 may further include a detection step of detecting at least one initial environmental parameter of each of the one or more control targets. In this case, STEP S303 of FIG. 3 may be conducted when the value difference between the at least one initial environmental parameter and the corresponding desired environmental parameter of at least one control target is greater than a predetermined value.

After determining the plural target adjustment parameter groups of the plural air conditioners, in STEP S304 of FIG. 3, the determined plural target adjustment parameter groups are respectively sent to the plural air conditioners, so that the plural air conditioners may set their adjustment functions, respectively.

As a result, in the control method according to this embodiment, it is possible to carry out, on the basis of the joint influence of all the possible air conditioners on one control target, automatic control with respect to the plural air conditioners in the air conditioning system, and in a case where there exist plural control targets having different desired environments in the space where the air conditioning system is provided, it is also possible to take account of the demands of the plural control targets so as to carry out the automatic control.

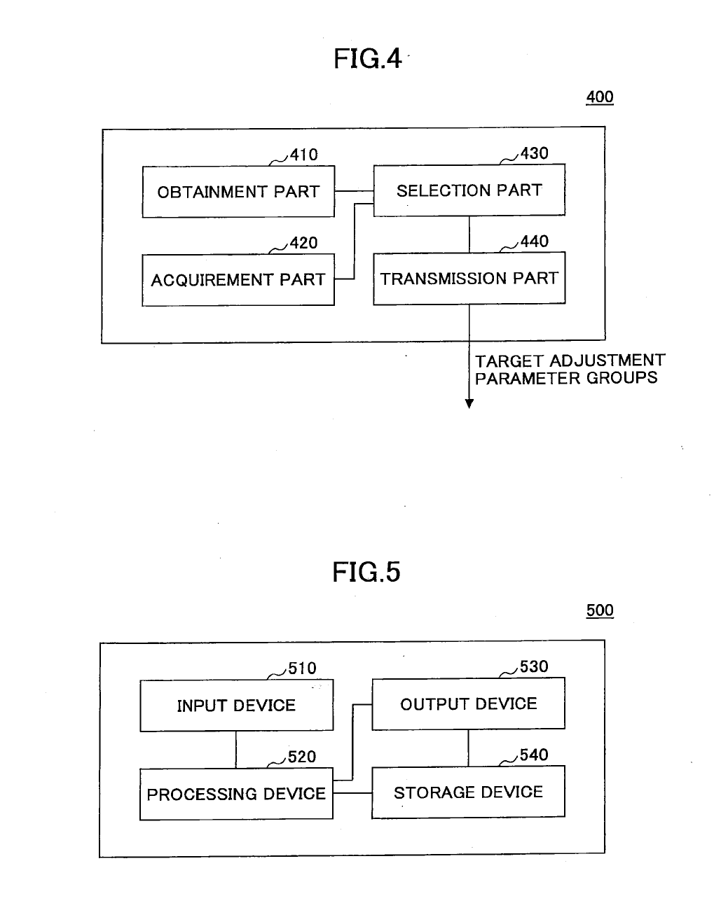

In what follows, a device for controlling an air conditioning system, according to an embodiment of the present invention will be given by referring to FIG. 4.

FIG. 4 is a block diagram of a device 400 for controlling the air conditioning system.

As shown in FIG. 4, the device (also called a “control device”) 400 includes an obtainment part 410, an acquirement part 420, a selection part 430, and a transmission part 440. The parts of the control device 400 may implement STEPS S301 to S304 of the control method shown in FIG. 3, respectively. As such, for the sake of convenience, the repeated descriptions are omitted here.

Here it should be noted that, in an example, the acquirement part 420 may include a receipt module for receiving environmental information determined in advance or in real time, on the basis of which at least one desired environmental parameter of each of one or more control targets may be generated, as described above. In this case, the acquirement part 420 may convert the received environmental information into the at least one desired environmental parameter of each of one or more control targets.

Furthermore, in an example, the control device 400 shown in FIG. 4 may further include a taking part and a generation part which may implement the above-described taking and generation steps, respectively. In this case, the taking part may include a sensor such as a temperature sensor, an air humility sensor, or an air flow sensor.

Additionally, in an example, the control device 400 may further include a setting part which may implement the above-describe setting step. In this case, the selection part 430 may select the target adjustment parameter group for each of the plural air conditioners by utilizing least squares fitting, as described above.

Moreover, considering that the amount of energy consumption should be reduced as much as possible, in an example, the control device 400 shown in FIG. 4 may further includes a giving part which may implement the above-described giving step.

In addition, in order to further reduce the amount of energy consumption, in an example, the control device 400 may further include a detection part which may implement the above-described detection step.

As a result, in the control device 400 according to this embodiment, it is possible to carry out, on the basis of the joint influence of all the possible air conditioners on one control target, automatic control with respect to the plural air conditioners in the air conditioning system. In addition, when there exist plural control targets having different desired environments in the space where the air conditioning system is provided, it is also possible to take into account the demands of the plural control targets so as to carry out the automatic control.

In what follows, a system (also called a “control system”) for controlling an air conditioning system, according to an embodiment of the present invention, will be given by referring to FIG. 5.

FIG. 5 is a block diagram of a control system 500 for controlling the air conditioning system containing plural air conditioners.

As shown in FIG. 5, the control system 500 includes an input device 510, a processing device 520, an output device 530, and a storage device 540.

The input device 510 is configured to input the air conditioning system related information from the outside, for example, the plural adjustment parameter groups of each of the plural air conditioners and the desire environmental parameter of each of one or more control targets predetermined by a user. In particular, the input device 510 may include but is not limited to a keyboard, a mouse, a communications network, a remote input device connected to the communications network, etc.

The processing device 520 is configured to implement the above-described control method according to the above embodiment. In particular, the processing device 520 may include but is not limited to a central processing unit of a computer, a chip having processing ability, etc. Furthermore the processing device 520 may also be connected to a network such as the Internet (not shown in the drawings), and may receive/transmit data from/to a remote server as needed.

The output device 530 is configured to output the plural target adjustment parameter groups obtained by carrying out the above-described control method according to the above embodiment to the outside, for example, a display, a printer, a network connected to the air conditioning system and/or the plural air conditioners thereof.

The storage device 540 is configured to store the relevant information such as the predetermined adjustment, parameters, and thresholds, the prior detection results, and the current adjustment parameters in a volatile or non-volatile way. In particular, the storage device 540 may include but is not limited to a random access memory, a read-only memory, a hard disk, a semiconductor memory, etc.

Here it should be noted that the above respective embodiments are just exemplary ones, and the specific structure and operation of each of them may not be used for limiting the present invention.

Moreover, the embodiments of the present invention may be implemented in any convenient form, for example, using dedicated hardware or a mixture of dedicated hardware and software. The embodiments of the present invention may be implemented as computer software implemented by one or more networked processing apparatuses. The network may comprise any conventional terrestrial or wireless communications network, such as the Internet. The processing apparatuses may comprise any suitably programmed apparatuses such as a general-purpose computer, personal digital assistant, mobile telephone (such as a WAP or 3G-compliant phone) and so on. Since the embodiments of the present invention can be implemented as software, each and every aspect of the present invention thus encompasses computer software implementable on a programmable device.

The computer software may be provided to the programmable device using any storage medium for storing processor-readable code such as a floppy disk, a hard disk, a CD ROM, a magnetic tape device or a solid state memory device.

The hardware platform includes any desired hardware resources including, for example, a central processing part (CPU), a random access memory (RAM), and a hard disk drive (HDD). The CPU may include processors of any desired type and number. The RAM may include any desired volatile or nonvolatile memory. The HDD may include any desired nonvolatile memory capable of storing a large amount of data. The hardware resources may further include an input device, an output device, and a network device in accordance with the type of the apparatus. The HDD may be provided external to the apparatus as long as the HDD is accessible from the apparatus. In this case, the CPU, for example, the cache memory of the CPU, and the RAM may operate as a physical memory or a primary memory of the apparatus, while the HDD may operate as a secondary memory of the apparatus.

While the present invention is described with reference to the specific embodiments chosen for purpose of illustration, it should be apparent that the present invention is not limited to these embodiments, but numerous modifications could be made thereto by those people skilled in the art without departing from the basic concept and technical scope of the present invention.

The present application is based on and claims the benefit of priority of Chinese Priority Patent Application No. 201410558426.9 filed on Oct. 20, 2014, the entire contents of which are hereby incorporated by reference.

What is claimed is:

1. A method of controlling an air conditioning system containing plural air conditioners, each of the plural air conditioners having at least one adjustment function able to conduct adjustment with respect to air, the method comprising:
an obtainment step of obtaining plural adjustment parameter groups of each of the plural air conditioners, wherein, each of the plural adjustment parameter groups of the corresponding air conditioner includes at least one adjustment parameter corresponding to the at least one adjustment function of the corresponding air conditioner, and a value of the at least one adjustment parameter indicates an operating state of the corresponding at least one adjustment function;
an acquirement step of acquiring at least one desired environmental parameter of each of one or more control targets;
a selection step of selecting, based on the desired environmental parameters, one from the plural adjustment parameter groups of each of the plural air conditioners to serve as a target adjustment parameter group of the corresponding air conditioner, wherein, at least one actual environmental parameter of each of the one or more control targets, which is obtained by conducting joint adjustment with respect to the corresponding control target by the plural air conditioners according to their target adjustment parameter groups, is closer to the corresponding at least one desired environmental parameter than that obtained by conducting adjustment with respect to the corresponding control target by the plural air conditioners according to their remaining adjustment parameter groups; and
a transmission step of respectively transmitting the plural target adjustment parameter groups to the plural air conditioners, so that the plural air conditioners respectively set their adjustment functions according to the plural target adjustment parameter groups.

2. The method according to claim 1, wherein:
there exists at least one adjustment parameter whose values in any two adjustment parameter groups of each of the plural air conditioners are different.

3. The method according to claim 1, further comprising:
a taking step of taking, in advance, an adjustment effect obtained when each of the plural air conditioners conducts adjustment with respect to each of the one or more control targets according to each of the plural adjustment parameter groups of the corresponding air conditioner;
a generation step of generating environment adjustment parameters corresponding to the adjustment effects; and
a determination step of determining, based on the environment adjustment parameters, the plural target adjustment parameter groups of the plural air conditioners, respectively.

4. The method according to claim 3, wherein:
the adjustment effect of the air conditioning system at one control target is superposition of the adjustment effects at the one control target generated by the plural air conditioners.

5. The method according to claim 3, wherein, the selection step and the determination step include:
by utilizing least squares fitting, selecting, based on the desired environmental parameters and the environment adjustment parameters, from the plural adjustment parameter groups of each of the plural air conditioners, the target adjustment parameter group for the corresponding air conditioner,
wherein, a sum of squares of value differences, between the at least one actual environmental parameter and the corresponding at least one desired environmental parameter of each of the one or more control targets, obtained when conducting joint adjustment with respect to the corresponding control target by the plural air conditioners according to their target adjustment parameter groups is less than that obtained when conducting adjustment with respect to the corresponding control target by the plural air conditioners according to their remaining adjustment parameter groups.

6. The method according to claim 1, further comprising:
a detection step of detecting at least one initial environmental parameter of each of the one or more control targets,
wherein, the selection step is conducted when a value difference, between the at least one desired environmental parameter and the at least one initial environmental parameter of at least one control target, is greater than a predetermined value.

7. A device for controlling an air conditioning system containing plural air conditioners, each of the plural air conditioners having at least one adjustment function able to conduct adjustment with respect to air, the device comprising:
an obtainment part configured to obtain plural adjustment parameter groups of each of the plural air conditioners, wherein, each of the plural adjustment parameter groups of the corresponding air conditioner includes at least one adjustment parameter corresponding to the at least one adjustment function of the corresponding air conditioner, and a value of the at least one adjustment parameter indicates an operating state of the corresponding at least one adjustment function;
an acquirement part configured to acquire at least one desired environmental parameter of each of one or more control targets;
a selection part configured to select, based on the desired environmental parameters, one from the plural adjustment parameter groups of each of the plural air conditioners to serve as a target adjustment parameter group of the corresponding air conditioner, wherein, at least one actual environmental parameter of each of the one or more control targets, which is obtained by conducting joint adjustment with respect to the corresponding control target by the plural air conditioners according to their target adjustment parameter groups, is closer to the corresponding at least one desired environmental parameter than that obtained by conducting adjustment with respect to the corresponding control target by the plural air conditioners according to their remaining adjustment parameter groups; and
a transmission part configured to respectively transmit the plural target adjustment parameter groups to the plural air conditioners, so that the plural air conditioners respectively set their adjustment functions according to the plural target adjustment parameter groups.

8. The device according to claim 7, further comprising:
a taking part configured to take, in advance, an adjustment effect obtained when each of the plural air conditioners conducts adjustment with respect to each of the one or more control targets according to each of the plural adjustment parameter groups of the corresponding air conditioner; and
a generation part configured to generate environment adjustment parameters corresponding to the adjustment effects,
wherein, the selection part further determines, based on the environment adjustment parameters, the plural target adjustment parameter groups of the plural air conditioners, respectively.

9. The device according to claim 8, wherein:
by utilizing least squares fitting, the selection part selects, based on the desired environmental parameters and the environment adjustment parameters, from the plural adjustment parameter groups of each of the plural air conditioners, the target adjustment parameter group for the corresponding air conditioner,
wherein, a sum of squares of value differences, between the at least one actual environmental parameter and the corresponding at least one desired environmental parameter of each of the one or more control targets, obtained when conducting joint adjustment with respect to the corresponding control target by the plural air conditioners according to their target adjustment parameter groups is less than that obtained when conducting adjustment with respect to the corresponding control target by the plural air conditioners according to their remaining adjustment parameter groups.

10. The device according to claim 7, further comprising:
a detection part configured to detect at least one initial environmental parameter of each of the one or more control targets,
wherein, the selection part conducts its own process when a value difference, between the at least one desired environmental parameter and the at least one initial environmental parameter of at least one control target, is greater than a predetermined value.
